(19) United States
(12) Patent Application Publication
(10) Pub. No.: US 2018/0311581 A1
(43) Pub. Date: Nov. 1, 2018

(54) METHOD FOR USING SIMULATED PHYSICS TO ANIMATE SLOT SYMBOL OBJECTS OF A SLOT VIDEO GAME

(71) Applicant: Julius Patta, Henderson, NV (US)

(72) Inventor: Julius Patta, Henderson, NV (US)

(21) Appl. No.: 15/796,260

(22) Filed: Oct. 27, 2017

Related U.S. Application Data
(60) Provisional application No. 62/490,787, filed on Apr. 27, 2017.

(51) Int. Cl. A63F 13/52; A63F 13/80; A63F 13/30

(52) U.S. Cl. CPC A63F 13/52; A63F 13/30; A63F 13/80

(57) ABSTRACT

A method for using simulated physics to animate slot symbol objects of a slot video game is disclosed. The method goes beyond the visual concept of reels spinning up or down by applying physics calculations to video slot symbol objects, resulting in new animated behavior of the video slot symbol objects outside of the constraints of a reel boundary or a pattern. Symbols exist as independent virtual objects susceptible to the laws of physics, within a virtual scene. The resulting visual behavior of flying, falling and otherwise interacting objects within the game scene produces a unique visual random experience every time the game is played. The applied method results extend the player game enjoyment with a new pseudo-random visual behavior of animating slot symbols.

### CLAIM OF BENEFIT TO PRIOR APPLICATION

This application claims benefit to U.S. Provisional Patent Application 62/490,787, entitled “METHOD FOR USING SIMULATED PHYSICS TO ANIMATE SLOT SYMBOL OBJECTS OF A SLOT VIDEO GAME,” filed Apr. 27, 2017. The U.S. Provisional Patent Application 62/490,787 is incorporated herein by reference.

### BACKGROUND

Embodiments of the invention described in this specification relate generally to simulation games, and more particularly, to a method for using simulated physics to animate slot symbol objects of a slot video game.

Slot games animate slot symbols mimicking the appearance and the downward or upward movement of reels, producing the visual effect of multiple spinning reels. The player's visual experience of present day slot games is limited to this effect. The visual effect dates back to early mechanical slot games with implementation of actual physical reels. Modern computing platforms are not restricted by mechanical interpretation, yet the spinning animation effect remains.

Existing methods of video slot game symbol animation limit the visual possibilities for user experience and enjoyment. Symbols and objects are arranged in simple patterns, and are animated using limited acceleration and deceleration simulation, giving the appearance of symbols spinning through the display. This fixed and static approach is ever-present in the video slot industry since inception to present day.

Animation of slots symbols beyond the visual concept of reels spinning up or down. The method relies on application of physics calculations to video slot symbol objects, resulting in new animated behavior, outside of the constraints of a reel boundary or a pattern. Symbols exist as independent virtual objects susceptible to the laws of physics, within a virtual scene. The resulting visual behavior of falling and otherwise interacting objects within the game scene produces a unique visually random experience every time the game is played. The applied method results extend the player game enjoyment with a new pseudo-random visual behavior of animating slot symbols.

Therefore, what is needed is a way to use simulated physics in the animation of video game slot symbol objects.

### BRIEF DESCRIPTION

A novel method for using simulated physics to animate slot symbol objects of a slot video game is disclosed. In some embodiments, the method goes beyond the visual concept of reels spinning up or down by applying physics calculations to video slot symbol objects, resulting in new animated behavior of the video slot symbol objects outside of the constraints of a reel boundary or a pattern.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having thus described the invention in general terms, reference is now made to the accompanying drawings, which are not necessarily drawn to scale, and which show different views of different example embodiments, and wherein:

FIG. 1 conceptually illustrates a method for using simulated physics to animate symbols of a typical round of playing the slot video game in some embodiments.

FIG. 2 conceptually illustrates an example of a user interacting with a slot video game that uses simulated physics to animate symbols of the slot video game.

FIG. 3 conceptually illustrates a detailed method for using simulated physics to animate symbols of a slot video game in some embodiments.

FIG. 4 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel method for using simulated physics to animate slot symbol objects of a slot video game. In some embodiments, the method for using simulated physics to animate slot symbol objects of a slot video game goes beyond the visual concept of reels spinning up or down. In some embodiments, the method applies physics calculations to video slot symbol objects, resulting in new animated behavior outside of the constraints of a reel boundary or a pattern. In some embodiments, the video slot symbol objects are created as independent virtual objects that are susceptible to applications of the laws of physics within a virtual video-based scene. In some embodiments, the method drops the video slot symbol objects, resulting in visual behavior of falling. In some embodiments, the method applies simulated force and torque to video slot symbol objects, resulting in visual behavior of objects flying through space, rotating and curving in trajectory. In some embodiments, the falling objects can interact with each other by colliding with each other with the computed laws of physics being applied to all movements and interactions of the objects. In this way, the method for using simulated physics to animate slot symbol objects of a slot video game produces a unique visually random experience every time the game is played. Additionally, the method for using simulated physics to animate slot symbol objects of a slot video game increase enjoyment of users who play the game with a new pseudo-random visual behavior of animating slot symbols.

Problems with existing slot games are addressed by embodiments of the method for using simulated physics to animate slot symbol objects of a slot video game. As stated above, existing slot games animate slot symbols by mimicking the appearance and the downward or upward movement of reels, thereby producing the visual effect of multiple spinning reels. The visual effect dates back to early mechanical slot games with implementation of actual physical reels. Modern computing platforms are not restricted by mechanical interpretation, yet the spinning animation effect remains. However, users who play the existing video slot games only enjoy a visual experience that is limited to this effect. Embodiments of the invention described in this specification solve such problems by presenting an alternate method for animating the virtual slot symbols or objects. Specifically, the virtual slot symbols or objects are animated using physics simulation, appearing to interact with each other and their animated scene and environment, which expands the end-user visual experience.

Embodiments of the method described in this specification differ from and improve upon currently existing conventional slot game options. In particular, some embodiments of the method differ from the conventional slot game options by applying the laws of physics to the simulation of the slot objects. In particular, several physical forces come into play during a slot game simulation, causing virtual slot symbols to fly or fall at speeds defined by physics laws (e.g., gravity defines a speed of acceleration, particles in space may impact speed, etc.), and bounce off each other in predictable manners according to various laws of physics. In this way, the visual experience of the slot game is greatly enhanced, as symbols appear to fall, accelerate, spin, bounce and interact with the entire virtual canvas of the digital display of the device on which the game is running.

In addition, the method improves upon the currently existing conventional slot game options which offer little variation of the basic game mechanics (i.e., its visual behavior). Specifically, the conventional slot game options are limited to simulating spinning virtual reels in a fixed field, offering limited creative interpretation of the slot game's outcome presentation. Such visual effect has become stale and repetitive. In contrast, the method of the present disclosure provides animation of slots symbols beyond the visual concept of reels spinning up or down. The method relies on application of physics calculations to video slot symbol objects, resulting in new animated behavior, outside of the constraints of a reel boundary or a pattern. Symbols exist as independent virtual objects susceptible to the laws of physics, within a virtual scene. The resulting visual behavior of falling and otherwise interacting objects within the game scene produces a unique visual random experience every time the game is played. The applied method results extend the player game enjoyment with a new pseudo-random visual behavior of animating slot symbols.

The method of the present disclosure may be comprised of the following steps and elements. This list of possible constituent steps and elements is intended to be exemplary only and it is not intended that this list be used to limit the method of the present application to just these steps or elements. Persons having ordinary skill in the art relevant to the present disclosure may understand there to be equivalent steps or elements that may be substituted within the present disclosure without changing the essential function or operation of the method. Furthermore, persons having ordinary skill in the relevant art may understand that the order of performing the steps of the method may differ without changing the overall function or operation of the method. Thus, the order of steps performed for the method are described here as an example to demonstrate what the method does overall.

1. Game Scene Preparation—prepare the video slot game scene, define boundaries, define simulated gravity

2. Game Round Preparation—prepare a game round in the slot video game scene

3. Game Animation Initiation—start animation for the game round, simulate application of physical force

4. Game Animation behavior—apply simulation of laws of physics to animation of each slot symbol object in the animation scene during the animation cycle

5. Game Animation Preparation for Conclusion—use computed random outcome data to apply at the conclusion of the game round

6. Game Animation Settling of Symbols—apply the outcome data to settle the virtual slot symbols at the end of the game round (the slot symbols settle to final positions)

7. Game Animation handling of screen rotation—apply detected rotation, and re-arrange the displayed scene respecting simulated laws of physics for gravity

8. Game Animation Conclusion—slot symbols take final placements

The various elements of the method of the present disclosure may be related in the following exemplary fashion. It is not intended to limit the scope or nature of the relationships between the various elements and the following examples are presented as illustrative examples only.

The method of the present disclosure generally works by applying the laws of physics to the animated display of virtual slot symbols. The method of some embodiments is implemented as a video slot game software application (“game software”). For a conventional-style video slot game, the game software displays a symbol array arranged according to a predesigned visual pattern. Conventional-style video slot game display arrangements include three rows of symbols by five columns (3×5), three by three (3×3), one by three (1×3), etc. When the game software animates the displayed slot symbols, it uses the visual effect which reminds players of physical spinning reels, where each column of symbols represents a slot machine reel. Symbols may be animated by moving a symbol from a start location on the video display, to an end location on the video display, top to bottom, column by column, to give the appearance of spinning reels.

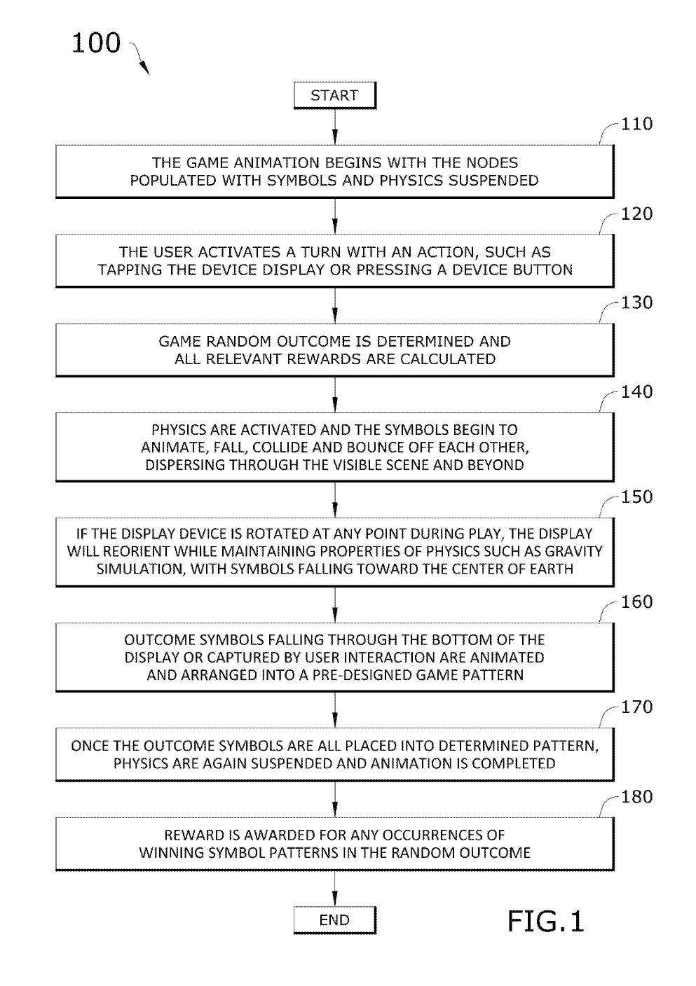

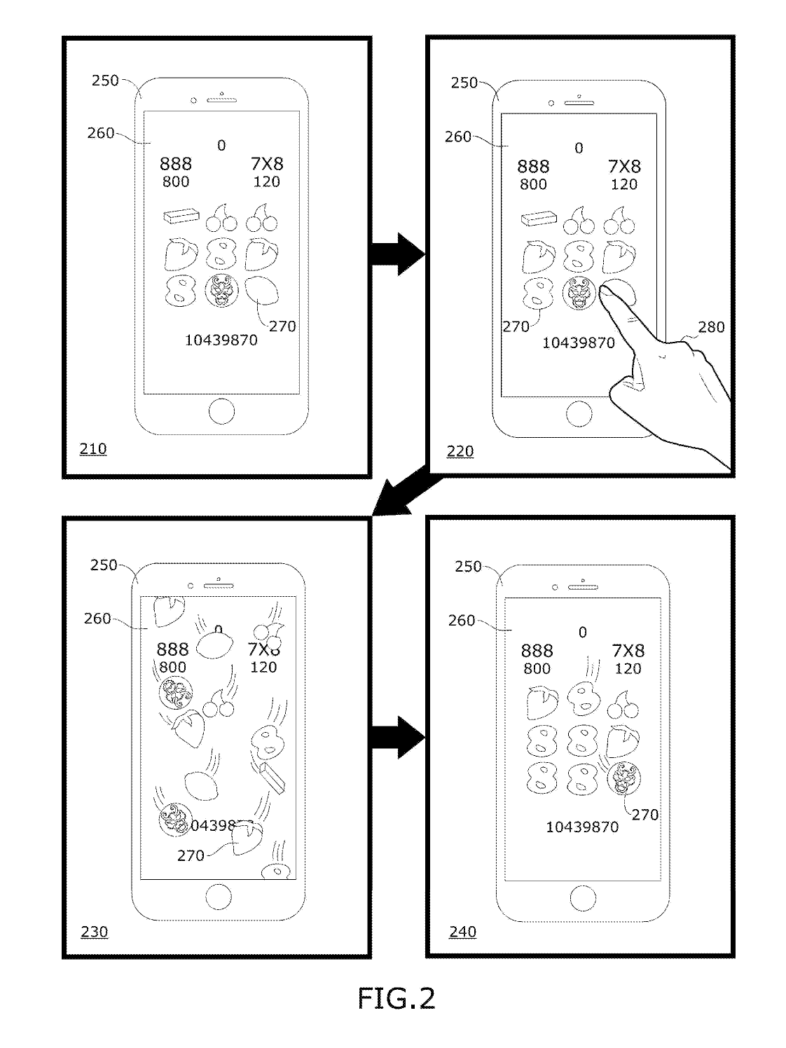

By way of example, FIG. 1 conceptually illustrates a method 100 for using simulated physics to animate symbols of a typical round of playing a slot video game. In describing the steps of the method 100, reference is made to FIG. 2, which conceptually illustrates four stages 210-240 of a user interacting with the slot video game which uses simulated physics to animate the symbols of the slot video game.

Starting with FIG. 1, the method 100 starts when the slot video game is running. In some embodiments, the method 100 first begins the game animation (at 110) with the nodes being populated with symbols. At this step, the physics simulation is suspended while the method 100 prepares the video slot game scene, defining the boundaries of the slot video game scene and canvas, defining simulated gravity, etc. The method 100 also prepares a game round for the slot video game scene. When implemented as a slot video game software application, this step configures an animation engine with physics simulation capabilities for the game animation. The slot video game software prepares a virtual game scene, a game canvas (or display area) described with properties to configure the scene for a physics animation simulation. The game scene is described as a hierarchy of virtual nodes.

In some embodiments, node content such as sprites, models, backgrounds, particles, textures, audio, text, etc. is preloaded for each virtual node and placed onto the scene either into an initial state, or a last-known valid state. Node objects animation and simulation outcome is a result of the configured physics properties of each object, and application of simulated forces of physics to the scene in key moments.

Turning to FIG. 2, a first stage 210 is shown with a mobile device 250 that includes a touch-sensitive screen. A graphical slot video game display 260 is visually output onto the touch-sensitive screen of the mobile device 250. Several slot video game symbols 270 are shown in the graphical slot video game display 260. The symbols 270 are not in motion during the first stage 210 because physics simulation is presently suspended, as noted above by reference to step 110 of the method 100 in FIG. 1.

Referring back to FIG. 1, the method 100 transitions to the next step (at 120) when a game player (or “user”) activates a turn with an action, such as tapping the graphical slot video game display 260 that is shown on the touch-sensitive screen of the mobile device 250. The method 100 prepares to start physics-based motion for the animation of the game round when the user taps the screen or otherwise performs an action to start the turn, during when the method 100 will simulate application of physical force to the slot symbols on the canvas of the game.

In some embodiments, physics-based motion and movement for the animation starts not only upon a user action, but can be started after a game process triggers the game animate phase of the method. For example, a non-human automated process may trigger the animation phase after a predetermined time has elapsed between rounds. Whatever the trigger is caused by, the method 100 of some embodiments receives the input and applies a simulated force to all relevant game nodes and their objects within the scene. All objects respond to that force and interact with the game scene's virtual physics environment.

In the second stage 220 of FIG. 2, such a user action 280 is shown. Note that in the second stage 220, the slot video game symbols 270 are still in the same positions of the graphical slot video game display 260 as they were shown in the first stage 210. However, the user gesture 280 shown in the second stage 220 acts as the trigger for the slot video game to activate the physics simulation of the slot video game symbols 270, which is shown in the third stage 230. In particular, the third stage 230 shows that the symbols 270 are now in a free fall animation. However, the physics simulation does not produce a random scattering of the symbols 270, but instead is bound to the physics of motion (e.g., due to propulsion, gravity, or simulated artificial gravitational-like force) and object interaction (e.g., symbols bumping into each other).

Now turning back to FIG. 1, the method 100 relies on the game's computation of random outcome data (shown at 130) to determine which outcome slot symbols to capture and present in final arrangement for player display. In some embodiments, the computation includes calculating all relevant rewards in connection with the outcome prior to starting the visible animation of slot symbols.

Next, the method 100 activates (at 140) physics and the slot symbols begin to animate, fall, collide, and bounce off each other. This results in the slow symbols dispersing through the visible scene and beyond. When the method 100 activates the physics, the method 100 applies simulation of laws of physics to animation of each slot symbol object in the animation scene during the animation cycle. For example, when physics with gravity are activated, the slot symbols on the game canvas begin to fall, collide, and bounce off each other (or otherwise interact), and thereafter disperse through the visible scene and beyond (e.g., off screen). The resulting visual outcome is a collection of slot symbols appearing to be moving through the display, colliding and bouncing off each other and designed scene boundaries and components. The node objects are moving dynamically through the scene according the forces applied to the scene and themselves.

While the triggering action described in FIGS. 1 and 2 involve a touch action (user taps a finger on the screen) to start physics to animate the slot symbols, it is noted that some implementations will involve another triggering action, such as user pressing a button or pulling a lever on a video slot game to begin a turn.

Also, in some embodiments, the user can rotate the device being used to play the slot video game without disrupting the animation of symbols. The method 100 handles such rotation (at 150) of the display device at any point or time during the slot video game turn (or during any other game play turn) by reorienting the graphical slot video game display 260 while maintaining the gravity simulation, with the slot symbols falling toward the center of the earth (with respect to the orientation of the device and its relative orientation to earth, that is). For example, the method 100 may receive relevant data from one or more sensors embedded in the user's computing device which detect rotation, thereby allowing the method 100 to reorganize its scene coordinates. The game display scene will appear to auto-rotate, and the concept of up/down, left/right is always preserved.

Although the slot symbols are not randomly scattered about the screen during the turn (being bound to the laws of physics), the method 100 of some embodiments detects symbols falling (at 160) off the bottom edge of the display and triggers the relevant symbol capture. Thus, the final pattern and placement of the slot symbols is predetermined by the game's computation of random outcome data (at 130) before the end of the turn based on the random number generation. While the method 100 described by reference to FIG. 1 includes detection of symbols falling off or through the bottom edge of the display and triggering the capture of the symbols, a person skilled in the relevant art would appreciate that some implementations of the method 100 may include adaptations of this behavior. For example, some implementations of the method may let the symbols collide with and bounce against some fixed object in the device interface, such as a floor, walls, or other surroundings displayed on the device, and then arrange the symbols into the final pattern once the bouncing subsides.

After the slot symbols are all placed into the predetermined final pattern and placement, the method 100 then suspends (at 170) physics. Specifically, the method 100 of some embodiments locks into place all captured slot outcome symbols and suspend their physics simulation. When all objects that represent an outcome are captured, then reward is awarded (at 180) for any occurrence of winning symbol patterns in the random outcome. In some embodiments, the method 100 simply awards points for any occurrences of winning symbol patterns. In some embodiments, the method 100 ends after the reward is awarded and animation of the slot symbols using physics simulation stops. The final steps of the method 100 are demonstrated in the fourth stage 240 of FIG. 2, which illustrates the final pattern and placement of the slot video game symbols 270 in the graphical slot video game display 260.

Thus, as can be understood by the descriptions of the method 100 of FIG. 1 and the exemplary demonstration of applying physics to the animation of slot symbols shown in stages 210-240 of FIG. 2, applying the laws of physics to the simulation of the slot objects allows enhanced user experience in playing a slot video game, with virtual slot symbols being bound to laws of physics as the slot symbols are visually output onto a virtual canvas consistent with physics-defined forces and motions, such as gravity, propulsion, flying, falling, accelerating, spinning, bouncing, interacting, or otherwise moving. Furthermore, the user can begin another turn by triggering the animation through a touch gesture or another supported manner. The user can continue playing turns over and over, each turn generally following the steps of the method 100 described by reference to FIG. 1, above.

Other animation techniques are used as well, including playing a video or “movie” of symbol animation, within the boundaries that define the symbols array. The spinning of reels is typically top to bottom, and the progression of reels is most often left to right. The slot game animation is over when the animation of reels settles to a stop, typically with the left most reel last, and game outcome animation is triggered to display the game outcome. Regardless of technique, the perceived visual outcome is the visual appearance of spinning reels.

In contrast to the conventional slot video games, the method of the present disclosure treats all objects on a display screen of a device as if they were real physical objects. When the physics (routines that calculate position, angle, etc.) are enabled, animated objects on the display screen will behave according to their properties. Such animated items will fly, fall, bounce, collide, ricochet, etc. The result is an animation that appears real, outside the bounds of a pretend, pre-packaged reel strip. While the slot symbols may start and end in similar grid arrangements as those in the conventional video slot games, the animation presented by way of the method described in this disclosure is quite unique during the in-play sequence, particularly in the visual behavior of physical objects as they are launched, as they fall, as they collide, or otherwise interact with each other.

The invention of the present disclosure is made by implementing the method as computer software, such as a slot video game. Modern code development practices rely on reuse of subroutines, modules, frameworks and external third-party components. While the animation method is unique, the use of such components or architecture is not. Nevertheless, each symbol or other desirable object is treated in software as a physical object. Animation techniques using physical object calculations are applied to the scene and to all objects on the scene. The start and end of the animation sequence is prescribed, and the in-play animation of the scenery is driven by simulation of physical forces applied to the environment. Examples of the simulated physical forces applied during the animated play include, without limitation, gravity, lift, torque, drag or friction, responding to properties including, without limitation, mass elasticity, and restitution; collectively used to compute simulation of laws of physics applied to objects in a video slot game environment.

While embodiments of the method described herein are implemented as animation software (e.g., a slot video game), it is noted here that implementations are assumed to be without limitation. Thus, the method may be implemented on any physical computing device that has a display screen or that is attached to a display screen. While certain computing devices provide enhanced visual output by hardware-based video acceleration, it is understood that such enhancements are not required for the method to apply in a software video game implementation. The computing devices which can run software that implement the method include, without limitation, mobile devices (such as smartphones, mobile phones, tablet computing devices, etc.), laptops, personal computers (PCs), video slot machines, lottery video terminals, and similar devices.

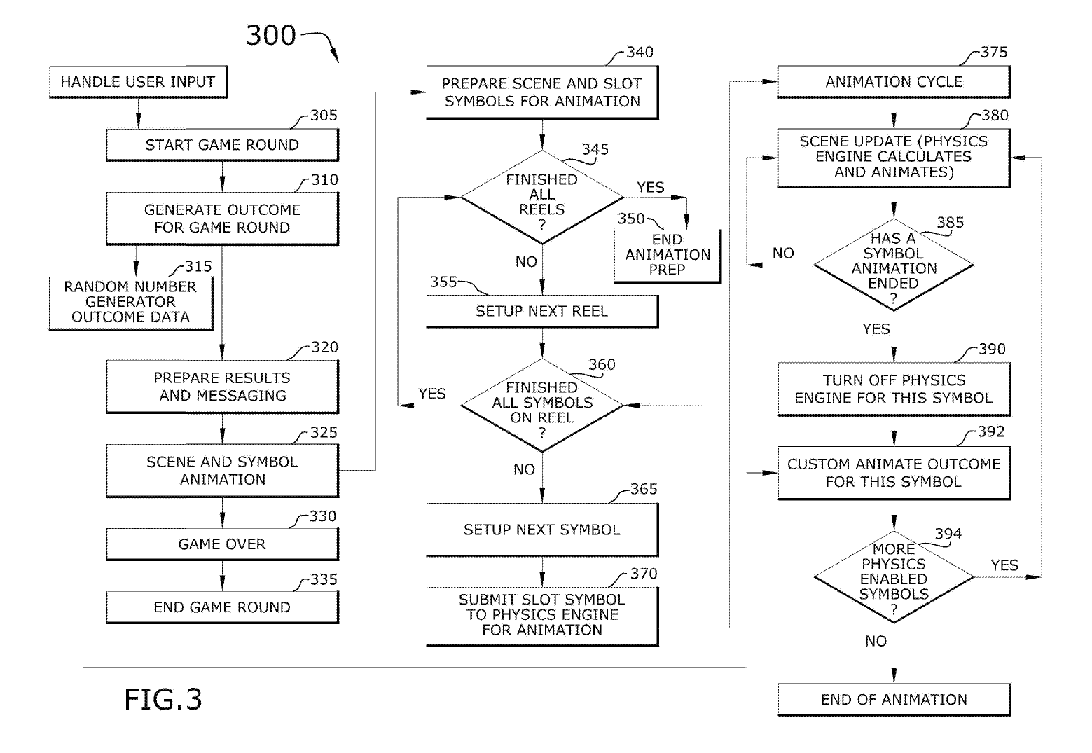

Turning to another example, FIG. 3 conceptually illustrates a detailed method 300 for using simulated physics to animate symbols of a slot video game. The detailed method 300 may be implemented as a slot video game on a mobile device, such as mobile device 250 described by reference to FIG. 2, or on a desktop computing device, tablet computing device, or another type of computing device. As shown in this figure, the detailed method 300 begins by handling user input. For example, the user may provide a touch gesture on the screen of a mobile device that is running the slot video game. Thus, the detailed method 300 starts a game round (at 305) and generates (at 310) the outcome for the game round. As noted above, the outcome is predetermined by generating the final pattern and placement of the slot symbols via random number generator (at 315).

In some embodiments, contemporaneously with the generating the outcome data (the final pattern and placement of the slot symbols, that is), the detailed method 300 prepares (at 320) results and messaging and starts scene and symbol animation (at 325) during which the slot symbols may begin to animate by application of physics, which is described in more detail below. After the scene and symbol animation, the final pattern and placement of the slot symbols (being predetermined by the random number generator) are visually output and the game is over (at 330). The detailed method 300 then ends the game round (at 335).

While the end of the game round (at 335) signifies a completion of the detailed method 300, there are several sub-steps to the detailed method 300, which are described next. In particular, the step (at 325) for scene and symbol animation is now described in greater detail. As shown in the method 300, the initial sub-step for scene and symbol animation (at 325) is to prepare the scene and slot symbols for animation (at 340). Next, the detailed method 300 determines (at 345) whether all reels have finished. When all reels are finished, then the detailed method 300 ends the animation preparation (at 350). On the other hand, when there are still unfinished reels, the detailed method 300 proceeds to the next sub-step of setting up the next reel (at 355). In some embodiments, the detailed method 300 then determines (at 360) whether all slot symbols on the present reel are finished or not. When all the slot symbols on the reel are finished, then the detailed method 300 transitions back to the determination (at 345) of whether all the reels are finished or not. However, when there are remaining slot symbols on the present reel that are unfinished, then the detailed method 300 sets up (at 365) the next slot symbol, and submits (at 370) the slot symbol to the physics engine for animation. In some embodiments, the detailed method 300 then returns to the determination (at 360) of whether all the slot symbols on the reel are finished.

However, in some embodiments, the detailed method 300 includes several sub-steps that are performed when the slot symbol is submitted (at 370) to the physics engine for animation, which are described next. In particular, when the slot symbol is submitted to the physics engine for animation, the detailed method 300 begins the animation cycle (at 375). When the animation cycle has started, the detailed method 300 performs a scene update (at 380) during which the physics engine calculates and animates slot symbol positions, motions, interaction behaviors, etc. The detailed method 300 then determines (at 385) whether a particular slot symbol animation has ended. When the animation of the particular slot symbol has not ended, the detailed method 300 returns to the scene update (at 380).

On the other hand, when the animation of the particular slot symbol has ended, the detailed method 300 turns off the physics engine (at 390) with respect to the particular slot symbol. Then the detailed method 300 custom animates (at 392) the outcome for the particular slot symbol. As there may be more slot symbols to animate, the detailed method 300 then determines (at 394) whether there are more physics enabled slot symbols remaining to be animated. When there are more slot symbols to animate, the detailed method 300 returns to the scene update (at 380). However, when there are no more slot symbols to animate, the detailed method 300 ends the animation.

Since the method treats graphics elements as physical objects with physical properties, within a graphical scene that simulates physical behavior of a real environment, the design of the software may use an animation engine with physics simulation capabilities. Therefore, a game may be implemented using a variety of engines, and architectural techniques, including home-grown subroutines for handling animation and physics calculations. Alternatively, the software may include custom-developed physics rules in other-worldly sense. For example, the known laws of physics can be applied in some implementations of the method while in other implementations, extra-worldly physics laws (pretend physics laws in a pretend virtual universe) can be developed and applied to the animation of the virtual slot objects. Thus, while the software for animation engines can be from any of the several off-the-shelf technologies which presently exist, it is also possible for customer to build the software entirely.

To use the method of the present disclosure, a game manufacturer would apply the laws of physics to the visual display of the virtual slot symbol objects. In doing so, such game manufacturers would benefit from the design of a new line of video slot games based on applying laws of physics to the simulated display of objects. This visual behavior seeks to redefine how user experiences slot games. The method of applying physics to virtual slot symbols would be used for game design, where the virtual slot symbols would appear to be animating differently that any game currently available in the marketplace. The actual software implementation will vary depending on practices with each manufacturer.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

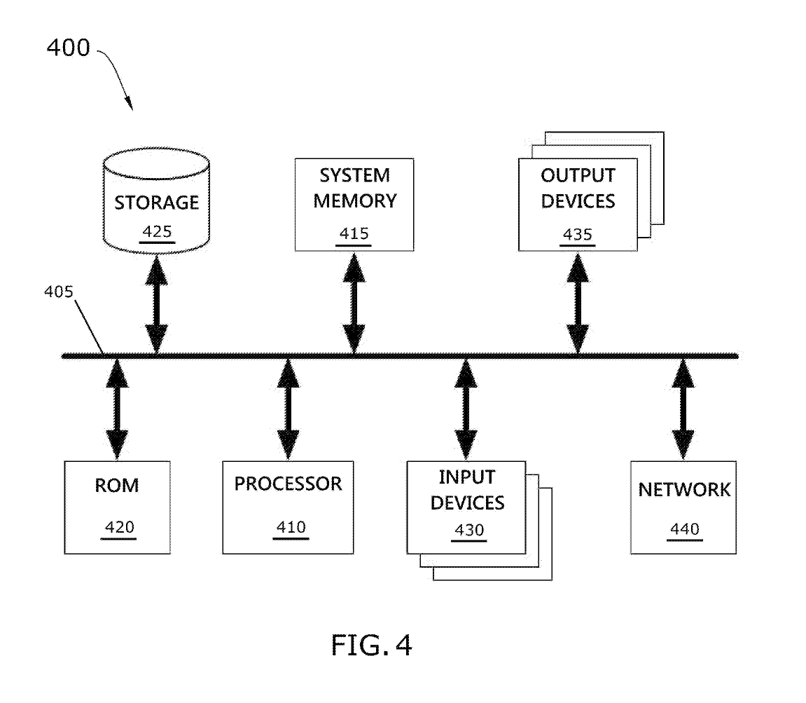

FIG. 4 conceptually illustrates an electronic system 400 with which some embodiments of the invention are implemented. The electronic system 400 may be a computer, phone, PDA, in-car computer, tablet computing device, smartphone mobile device, or any other sort of electronic device. Such an electronic system includes various types of computer readable media and interfaces for various other types of computer readable media. Electronic system 400 includes a bus 405, processing unit(s) 410, a system memory 415, a read-only 420, a permanent storage device 425, input devices 430, output devices 435, and a network 440.

The bus 405 collectively represents all system, peripheral, and chipset buses that communicatively connect the numerous internal devices of the electronic system 400. For instance, the bus 405 communicatively connects the processing unit(s) 410 with the read-only 420, the system memory 415, and the permanent storage device 425.

From these various memory units, the processing unit(s) 410 retrieves instructions to execute and data to process in order to execute the processes of the invention. The processing unit(s) may be a single processor or a multi-core processor in different embodiments.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some embodiments of the invention use a mass-storage device (such as a magnetic or optical disk and its corresponding disk drive) as the permanent storage device 425.

Other embodiments use a removable storage device (such as a floppy disk or a flash drive) as the permanent storage device 425. Like the permanent storage device 425, the system memory 415 is a read-and-write memory device. However, unlike storage device 425, the system memory 415 is a volatile read-and-write memory, such as a random access memory. The system memory 415 stores some of the instructions and data that the processor needs at runtime. In some embodiments, the invention's processes are stored in the system memory 415, the permanent storage device 425, and/or the read-only 420. For example, the various memory units include instructions for processing appearance alterations of displayable characters in accordance with some embodiments. From these various memory units, the processing unit(s) 410 retrieves instructions to execute and data to process in order to execute the processes of some embodiments.

The bus 405 also connects to the input and output devices 430 and 435. The input devices enable the user to communicate information and select commands to the electronic system. The input devices 430 include alphanumeric keyboards and pointing devices (also called “cursor control devices”). The output devices 435 display images generated by the electronic system 400. The output devices 435 include printers and display devices, such as cathode ray tubes (CRT) or liquid crystal displays (LCD). Some embodiments include devices such as a touchscreen that functions as both input and output devices.

Finally, as shown in FIG. 4, bus 405 also couples electronic system 400 to a network 440 through a network adapter (not shown). In this manner, the computer can be a part of a network of computers (such as a local area network (“LAN”), a wide area network (“WAN”), or an intranet), or a network of networks (such as the Internet). Any or all components of electronic system 400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1 and 3 conceptually illustrate methods (or processes). The specific operations of each method (or process) may not be performed in the exact order shown and described. Specific operations may not be performed in one continuous series of operations, and different specific operations may be performed in different embodiments. Furthermore, each method (or process) could be implemented using several sub-methods or sub-processes (i.e., the detailed method of FIG. 3), or as part of a larger macro method (or process). Thus, one of ordinary skill in the art would understand that the invention is not to be limited by the foregoing illustrative details, but rather is to be defined by the appended claims.

I claim:

1. A non-transitory computer readable medium storing a program which, when executed by a processor of a computing device, uses simulated physics to animate slot symbol objects of a slot video game, said program comprising sets of instructions for:
preparing a slot video game scene on a display screen of the computing device;
preparing a slot game round in the slot video game scene;
starting an animation for the slot game round;
applying a set of laws of physics to slot symbol objects in the animation;
applying a set of motions to the slot symbol objects during the animation; and
visually displaying a final slot configuration in which the slot symbol objects take positions in a final slot pattern.

2. The non-transitory computer readable medium of claim 1, wherein the set of laws of physics comprise gravity.

3. The non-transitory computer readable medium of claim 2, wherein the set of laws of physics further comprise at least one of lift, drag, friction, elasticity, and restitution.

4. The non-transitory computer readable medium of claim 2, wherein the set of motions comprise falling.

5. The non-transitory computer readable medium of claim 4, wherein the falling motion in the set of motions is applied to the slot symbol objects in connection with gravity in the set of laws of physics.

6. The non-transitory computer readable medium of claim 4, wherein the set of motions further comprise at least one of flying, colliding, and rotating.

7. The non-transitory computer readable medium of claim 6, wherein each motion in the set of motions is applied to the slot symbol objects in connection with gravity in the set of laws of physics.

8. The non-transitory computer readable medium of claim 1, wherein the program further comprises a set of instructions for generating slot game round outcome data that determines the final pattern.

9. The non-transitory computer readable medium of claim 8, wherein the set of instructions for generating slot game round outcome data comprises a set of instructions for using a random number generator to generate the slot game round outcome data.

10. The non-transitory computer readable medium of claim 9, wherein the slot game round outcome data determines a slot symbol object for each position in a plurality of positions of the final slot pattern.
